(19) United States
(12) Patent Application Publication
(10) Pub. No.: US 2007/0037947 A1
(43) Pub. Date: Feb. 15, 2007

(54) PROCESS FOR COVERING THE DEMAND FOR POLYMERS I WHICH COMPRISE AT LEAST 90% OF THEIR WEIGHT OF ACRYLIC ACID, SALTS THEREOF AND/OR ALKYL ESTERS OF ACRYLIC ACID IN FREE-RADICALLY POLYMERIZED FORM

(75) Inventors: Ulrich HAMMON, Mannheim (DE); Klaus Joachim Muller-Engel, Stutensee (DE); Ulrich Jager, Roemerberg (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/460,839

(22) Filed: Jul. 28, 2006

Related U.S. Application Data
(60) Provisional application No. 60/707,555, filed on Aug. 12, 2005.

(30) Foreign Application Priority Data
Aug. 12, 2005 (DE) 10 2005 038 412.9

(51) Int. Cl. C08F 20/06

(52) U.S. Cl. 526/317.1

(57) ABSTRACT

A process for covering the demand for polymers I in a country I, in which the monomers of the polymer I are obtained in at least one country II, then these monomers are polymerized free-radically to polymer I in this country II, and polymer I thus obtained is subsequently exported to a country I.

The present invention relates to a process for covering the demand for polymers I which comprise, to an extent of at least 90% of their weight, acrylic acid, salts thereof and/or alkyl esters of acrylic acid in free-radically polymerized form, in at least one of the countries I from the group comprising the United States of America, Japan, Hong Kong, Singapore, South Korea, Taiwan, Indonesia, Thailand, China, Germany, England, France, Italy, Belgium, The Netherlands, Sweden, Switzerland, Norway, Finland, Denmark, Canada, Poland, the Czech Republic, Romania, Bulgaria, Spain, India, Pakistan, Portugal, Austria and South Africa.

It is common knowledge that acrylic acid can be prepared by heterogeneously catalyzed partial gas phase oxidation of propylene and/or of propane with molecular oxygen over catalysts in the solid state of matter (cf., for example, EP-A 731 077, EP-A 1 254 709, EP-A 1 192 987, EP-A 1 193 240, DE-A 198 35 247, EP-A 895 809, DE-A 101 01 695, EP-A 293 224, EP-A 1 106 598, EP-A 990 636, DE-A 10 2005 009 885, DE-A 10 2004 003 212, DE-A 10 2005 013 039, DE-A 10 2005 009 891, DE-A 10 2005 010 111 and DE-A 102 45 585). Also included are processes in which, in the first reaction stage, propane is dehydrogenated and/or oxydehydrogenated partially to propylene and the resulting propylene is subsequently oxidized partially in the presence of the remaining propane (cf., for example, DE-A 102 45 585 and literature cited in this document). It is also known that acrylic acid can be esterified with alkanols, especially C₁- to C₈-alkanols, especially the monohydric alkanols, to give alkyl esters (this term also comprises hydroxyalkyl esters here) (cf. EP-A 677 506, EP-A 694 524, EP-A 984 918 and EP-A 609 127). The acrylic acid (if appropriate also its salts, for example its alkali metal and/or ammonium salts which are obtainable by neutralization of acrylic acid with the corresponding bases such as alkali metal hydroxide (e.g. KOH, NaOH) or ammonia) and/or their alkyl esters are subsequently frequently polymerized to polymers I which comprise, to an extent of at least 90% of their weight, acrylic acid, salts thereof and/or alkyl esters thereof (alkyl acrylates) in free-radically polymerized form, and are employed for a wide variety of different uses (for example as adhesives, as water-superabsorbing resins or as binders). If appropriate, neutralization can also be effected after the polymerization.

The aim is to prepare both acrylic acid, its salts and its alkyl acrylates, and the polymers I with maximum economic viability. The procedure for this purpose is typically that the raw material base for the propane and/or propylene i.e. crude oil or distillates thereof and/or natural gas, is exported from the regions of its natural occurrence into the countries I. There, mixtures of lower hydrocarbons are obtained from higher hydrocarbons present in these raw materials by thermal cracking at elevated temperatures and possibly under pressure, and also, if appropriate, in the presence of steam (“steamcracking”) or catalysts (for example hydrosilicate; “catalytic cracking”), and the propylene and propane present in these mixtures are isolated in good purity from these mixtures in the distillative separation thereof in so-called splitters. The propane and/or propylene thus obtained is then used in countries I, inter alia, for preparing acrylic acid. Esterification and subsequent free-radical polymerization of acrylic acid (if appropriate also of salts thereof, for example alkali metal salts thereof) and/or alkyl esters thereof to obtain polymers I proportionately to the demand forms the current procedure for covering the demand for polymers I in countries I.

A disadvantage of this procedure is that, in the countries I, there exists an overwhelming demand for propane and propylene for purposes other than acrylic acid preparation. For instance, the propylene is used predominantly for preparing polypropylene with several times the demand. Propane is used predominantly for energy generation. In other words, merely a comparatively small volume of the demand for propylene or propane is used for acrylic acid preparation in the countries I. The consequence is that the acrylic acid raw material basis in the countries I is comparatively expensive.

It has therefore already been proposed to shift the preparation of acrylic acid into one of those countries II in which, although crude oil and natural gas are processed, they are further processed chemically to a very limited degree.

Such countries II include the People's Republic of Yemen, Oman, Lybia, Bahrain, Qatar, Saudi Arabia, Iran, Iraq, the United Arab Emirates, Egypt, Kuwait, Venezuela, Brazil, Mexico, Nigeria, Russia, Kazakhstan, Uzbekistan, Turkmenistan, Algeria, Syria, Jordan and Yemen.

For example, it would be possible in these countries to use the crude propanes (comprise not only propane but also at least one constituent other than propane) occurring as a by-product in the aforementioned raw material extraction) directly for a direct oxidation for preparing acrylic acid. Alternatively, it would be possible to dehydrogenate the propane partially to propylene and subsequently to further process the resulting propylene to give acrylic acid. In neither case is a cracker required. As a consequence of the subsequent chemistry which is essentially not present in countries II, such available propane an/or propylene would be available extremely inexpensively. The same applies to propane and/or propylene obtained in any refinery crackers operated in these countries. In refinery crackers, comparatively high-boiling crude oil fractions are converted to comparatively low-boiling gasolines and (mineral oil) middle distillates.

Acrylic acid produced so particularly inexpensively in countries II could then be exported to countries I and further processed therein to cover the demand for polymers I.

However, a disadvantage of such a procedure is that acrylic acid has a marked tendency to undesired free-radical polymerization. Shipping of acrylic acid from countries II into countries I would generally go through different climate zones. The acrylic acid to be shipped is either exposed to a wide variety of temperatures or has to be shipped under thermostated conditions in a costly and inconvenient manner. In any case, it has to comprise significant additions of added polymerization inhibitors during shipping (this also applies to shipping of its esters or salts), which subsequently have a disruptive effect in the preparation of polymers I. Moreover, acrylic acid left alone, by condensation reaction with itself, forms first dimeric Michael adducts and, by condensation with them, Michael oligomers. These likewise have an adverse effect in the preparation of polymers I.

It was therefore an object of the present invention to provide a process for covering the demand for polymers I in at least one of the countries I which does not have the disadvantages described of the prior art processes.

Accordingly, a process has been found for covering the demand for polymers I which comprise, to an extent of at least 90% of their weight, acrylic acid and/or alkyl esters of acrylic acid in free-radically polymerized form, in at least one of the countries I from the group comprising the United States of America, Japan, South Korea, Taiwan, Indonesia, Thailand, China, Germany, England, France, Italy, Belgium, the Netherlands, Sweden, Switzerland, Norway, Finland, Denmark, Canada, Poland, the Czech Republic, Romania, Bulgaria, Spain, India, Pakistan, Portugal, Austria and South Africa, which comprises producing acrylic acid by heterogeneously catalyzed partial oxidation of propylene and/or propane in at least one of the countries II selected from the group comprising the People's Republic of Yemen, Oman, Lybia, Bahrain, Qatar, Saudi Arabia, Iran, Iraq, the United Arab Emirates, Egypt, Kuwait, Venezuela, Brazil, Mexico, Nigeria, Russia, Kazakhstan, Uzbekistan, Turkmenistan, Algeria, Syria, Jordan, Malaysia and Yemen, neutralizing the acrylic acid in at least one country II if required with a base to form a salt or esterifying it with an alkanol, and polymerizing acrylic acid thus produced, salts thereof and/or alkyl esters thereof in at least one country II free-radically to give polymers I and subsequently exporting polymer I thus obtained, if appropriate also in a form neutralized subsequently with a base, into at least one of the countries I.

The reason for the advantage of the inventive procedure is that the preparation of acrylic acid in at least one country II is particularly inexpensive by virtue of the prices for the propane and/or propylene raw materials required for the preparation of acrylic acid being disproportionately low. Shipping of “acrylic acid” in the form of polymers I from countries II to countries I is then, in contrast to shipping of acrylic acid itself, possible substantially without disadvantages. Overall, the demand for polymers I in countries I can be covered less expensively in the inventive manner than is possible by the prior art processes. According to the invention, useful processes for preparing acrylic acid from propane and/or propylene in countries II include in principle all known prior art processes.

However, preference will be given in accordance with the invention to employing one of those processes as described, for example, in EP-A 731 077, DE-A 102 45 585, DE-A 10 2005 009 885, DE-A 10 2004 003 212, DE-A 10 2005 013 039, DE-A 10 2005 009 891 and DE-A 10 2005 010 111.

In this process, crude propane (this is understood to mean propane which comprises at least one analytically detectable constituent other than propane), in a first step, is subjected to at least one partial dehydrogenation process selected from the group comprising homogeneous dehydrogenation, heterogeneously catalyzed dehydrogenation and heterogeneously catalyzed oxydehydrogenation to obtain a gas mixture 1 comprising propane and propylene.

If appropriate, an amount of the constituents other than propane and propylene present therein is subsequently removed from the gas mixture 1 formed in the first step or from a portion thereof with the same composition and/or converted to other compounds to obtain, from gas mixture 1, in each case a gas mixture 1′ comprising propane and propylene, and then, in at least one further step, gas mixture 1 and/or gas mixture 1′ is subjected as a constituent of a gas mixture 2 (obtainable in the simplest manner, for example, by adding molecular oxygen, air or another mixture of molecular oxygen and inert gas to gas mixture 1 and/or gas mixture 1′; the required oxygen may already have been added beforehand in the generation of gas mixture 1) to a heterogeneously catalyzed gas phase partial oxidation of propylene present in gas mixture 1 and/or gas mixture 1′.

In the simplest variant, all steps of the process according to the invention are carried out in a single reaction zone and over a catalyst charge disposed therein, as described, for example, in the documents EP-A 608838, EP-A 529853, DE-A 19835247, EP-A 895809, EP-A 1192987, DE-A 10029338, WO 99/03825, DE-A 10118814, DE-A 10119933, EP-A 603836, DE-A 19832033, DE-A 19836359, EP-A 962253 and EP-A 1193240. From the product gas mixture obtained, the acrylic acid can then be removed as described in WO 04089856 and unconverted propane and propylene recycled into the reaction zone.

However, preference is given to realizing the different steps in more than one reaction zone, as described, for example, in EP-A 938463, EP-A 117146, DE-A 3313573, GB-A 2118939, U.S. Pat. No. 31,611,670, WO 01/96270, EP-A 731077, DE-A 19837520, DE-A 10245585, DE-A 102005009885, DE-A 102004003212, DE-A 10200501303, DE-A 102005013039, DE-A 102005009891 and DE-A 102005010111. The acrylic acid can likewise be removed from the resulting product gas as described in these documents. The same applies to the recycling of unconverted propane and propylene.

The resulting acrylic acid removed in pure form can, proportionately to the demand, be neutralized with a base to give its salts (for example with a metal hydroxide or with amines) or esterified with mono- or polyhydric alkanols which preferably have 1 to 8 carbon atoms and are advantageously monohydric, by the route of a direct reaction to obtain the corresponding alkyl acrylates. Useful esterification catalysts include, for example, sulfuric acid, organic sulfonic acids (for example p-toluenesulfonic acid, methanesulfonic acid, benzenesulfonic acid or dodecylbenzenesulfonic acid) or sulfonic acid ion exchangers. For example, the esterification may be effected as described in the documents DE-A 19604252, EP-A 784046, EP-A 781759, EP-A 790230 and EP-A 795536. Preferred esterification alkanols are methanol, ethanol, propanol, n-butanol, tert-butanol, sec-butanol and 2-ethylhexanol. Preferred bases are the alkali metal hydroxides, especially KOH and NaOH, and also NH₃.

Preferably in accordance with the invention, polymers I have, to an extent of at least 95% of their weight and most preferably to an extent of at least 98% of their weight, acrylic acid, salts thereof and/or alkyl esters of acrylic acid in free-radically polymerized form. The acrylic acid may be polymerized either as such or in the form of one of its salts, for example its alkali metal salts (e.g. sodium and/or potassium salt). It will be appreciated that the polymers I may also, after their preparation by free-radical polymerization, have been partly or fully neutralized by means of NaOH and/or KOH and, if appropriate, with NH₃ (or with another base). It will be appreciated that it is also possible to neutralize with the corresponding carbonates or hydrogencarbonates. In other words, in principle, it is possible to effect partial or full neutralization with, for example alkali metal hydroxide and/or ammonium hydroxide before the free-radical polymerization and/or on completion of free-radical polymerization.

Polymers I suitable as superabsorbents are described, for example, in DE-A 10221202, DE-A 10221203 and in EP-A 1506153. They generally do not comprise any, or comprise at most in amounts of up to 10% by weight, esters of acrylic acid in polymerized form.

In other words, they are normally polymers I which comprise, to an extent of at least 90% or to an extent of at least 95% of their weight, acrylic acid and/or salts thereof, especially their alkali metal and/or ammonia salts (preferably their sodium salt) in polymerized form. To optimize properties of the superabsorbents, it may be advisable also to use monoethylenically unsaturated comonomers which do not bear any acid group. These include nitrites such as acrylonitrile, methacrylonitrile, amides such as acrylamide and methacrylamide, N-vinylamides such as N-vinylformamide, N-vinylacetamide and N-vinylpyrrolidone, vinyl esters of unsaturated C₁-C₄-carboxylic acids such as vinyl formate, vinyl acetate and vinyl propionate, but also esters of monoethylenically unsaturated C₃-C₆-carboxylic acids. Further suitable monoethylenically unsaturated comonomers free of acid groups are styrene and alkyl-substituted styrenes such as ethylstyrene or tert-butylstyrene. Such comonomers may quite generally be constituents of polymers I.

Frequently, polymers I suitable as superabsorbents also comprise small amounts (generally from 0.01 to 3% of their weight) of crosslinking comonomers in polymerized form. Examples include comonomers which have 2, 3, 4 or 5 ethylenically unsaturated double bonds in the molecule. Examples thereof are divinylbenzene and allyl acrylate. It is also possible for saturated or unsaturated polyfunctional compounds which have at least two (e.g. 2, 3, 4 or 5) functional groups which, with regard to their reactivity, are complementary to the carboxyl group of acrylic acid or salts thereof (especially alkali metal salts thereof) to act as crosslinking compounds. However, useful crosslinkers are also monoethylenically unsaturated compounds which, in addition to the ethylenically unsaturated double bond, have a further functional group complementary to carboxyl groups.

Examples thereof are hydroxyalkyl acrylates and hydroxyalkyl methacrylates. Useful crosslinkers are also polymers having a multitude of such complementary functional groups.

Suitable initiators for preparing polymers I are especially peroxo compound such as organic peroxides, organic hydroperoxides, hydrogen peroxide, persulfates, perborates, azo compounds and redox initiator systems. The preparation of a superabsorbent can also include internal postcrosslinking. To this end, the free-radically obtained polymer, before it is dried, is reacted with compounds which have at least two groups reactive toward carboxyl groups or-COO^{Θ} groups. This reaction can be effected at room temperature or at elevated temperatures up to 220° C. Polymers I are intended to include such crosslinked polymers.

It should be emphasized at this point that all percentages by weight which relate to polymers I always relate to polymers I calculated on an “anhydrous” basis (i.e. fully dry).

It will be appreciated that polymers I also include those polymers which, as described, have been obtained by free-radical polymerization, dried and, if appropriate, comminuted and subsequently surface crosslinked. For surface crosslinking, preference is given to using compounds which have at least two functional groups which can react with the functional groups, preferably the carboxyl or carboxylate groups, of the polymer with crosslinking. To this end, the postcrosslinking agents, preferably in the form of an aqueous solution, are applied to the surface of the polymer particles. The aqueous solution may comprise water-miscible organic solvents. Suitable postcrosslinking agents are, for example, di- or polyglycidyl compounds, diols and polyols, and polyamines and polyamidoamines. The crosslinker solution is applied preferably by spraying of a solution of the crosslinker.

Otherwise, the procedure to prepare water-superabsorbing polymers I may be as in the prior art already cited. The preparation of superabsorbent polymers I is also described in “Modern Superabsorbent Polymer Technology”, edited by F. L. Buchholz and A. T. Graham, Wiley-VCH (1998), and also in the documents EP-A 445619, DE-A 19846413, WO-A 01/38402, DE-A 3825366, U.S. Pat. No. 6,241,928, EP-A 457660, WO-A 02/94328, EP-A 955086 and WO-A 02/94329, and also in the prior art cited in these documents.

Otherwise, polymers I may be prepared quite generally by free-radical bulk, solution, emulsion (in particular aqueous) and suspension polymerization. These methods are known per se to those skilled in the art and described, for example, in DE-A 19602391 and WO 9727222. In general, polymers I will be exported to at least one of the countries I by sea. However, shipping as airfreight or in rail or in road vehicles is also possible in principle. The polymers I can be shipped in substance, as a solution, as an aqueous emulsion or an aqueous suspension.

It is also possible to proceed in a manner corresponding to that in the process according to the invention in covering the demand for polymers which are formed mainly from acrylonitrile or from methacrylonitrile or from esters of methacrylic acid. In other words, the partial oxidation or partial ammoxidation of the corresponding precursor compound, including, if appropriate, subsequent neutralization or esterification proportionately to the demand, is, just like the polymerization, effected in countries II and the resulting polymer is transferred to countries I.

What is claimed is:

1. A process for covering the demand for polymers I which comprise, to an extent of at least 90% of their weight, acrylic acid, salts thereof and/or alkyl esters of acrylic acid in free-radically polymerized form, in at least one of the countries I from the group comprising the United States of America, Japan, Hong Kong, Singapore, South Korea, Taiwan, Indonesia, Thailand, China, Germany, England, France, Italy, Belgium, the Netherlands, Sweden, Switzerland, Norway, Finland, Denmark, Canada, Poland, the Czech Republic, Romania, Bulgaria, Spain, India, Pakistan, Portugal, Austria and South Africa, which comprises producing acrylic acid by heterogeneously catalyzed partial oxidation of propylene and/or propane in at least one of the countries II selected from the group comprising the People's Republic of Yemen, Oman, Lybia, Bahrain, Qatar, Saudi Arabia, Iran, Iraq, the United Arab Emirates, Egypt, Kuwait, Venezuela, Brazil, Mexico, Nigeria, Russia, Kazakhstan, Uzbekistan, Turkmenistan, Algeria, Syria, Jordan, Malaysia and Yemen, neutralizing the acrylic acid in at least one country II if required with a base to form a salt or esterifying it with an alkanol, and polymerizing acrylic acid thus produced, salts thereof and/or alkyl esters thereof free-radically in at least one country II to give polymers I and subsequently exporting polymer I thus obtained, if appropriate also in a form neutralized subsequently with a base, into at least one of the countries I.

2. The process according to claim 1, wherein the polymer I comprises, to an extent of at least 95% of its weight, acrylic acid, salts thereof and/or alkyl esters of acrylic acid in free-radically polymerized form.

3. The process according to claim 1, wherein the polymer I comprises, to an extent of at least 90% of its weight, acrylic acid and/or salts thereof in free-radically polymerized form.

4. The process according to claim 1, wherein the polymer I comprises, to an extent of at least 95% of its weight, acrylic acid and/or salts thereof in free-radically polymerized form.

5. The process according to any of claims 1 to 4, wherein the process for preparing acrylic acid is a heterogeneously catalyzed partial oxidation of propylene.

6. The process according to claim 5, which starts from crude propane which is subjected in a first step to at least one partial dehydrogenization process selected from the group comprising homogenous dehydrogenization, heterogeneously catalyzed dehydrogenization and heterogeneously catalyzed oxydehydrogenization to obtain a gas mixture 1 comprising propane and propylene,
and in which, if appropriate, an amount of the constituents other than propane and propylene present therein is subsequently removed from gas mixture 1 or from a portion thereof with the same composition and/or converted to other compounds to obtain, from gas mixture 1, in each case a gas mixture 1′ comprising propane and propylene, and then, in at least one further step, gas mixture 1 and/or gas mixture 1′ is subjected as a constituent of a gas mixture 2 to a heterogeneously catalyzed gas phase partial oxidation of propylene present in gas mixture 1 and/or gas mixture 1′.
